(19) United States
(12) Patent Application Publication
(10) Pub. No.: US 2025/0282304 A1
(43) Pub. Date: Sep. 11, 2025

(54) MAT FOR BASE PLATE WITH APERTURES

(71) Applicant: Ford Global Technologies, LLC, Dearborn, MI (US)

(72) Inventors: Matthew B. Rutman, Westland, MI (US); Norbert Zolnai, Windsor (CA); Blaise Nugent, Brighton, MI (US); Eric Scott Levine, Novi, MI (US); Stuart C. Salter, White Lake, MI (US)

(21) Appl. No.: 18/600,626

(22) Filed: Mar. 8, 2024

(51) Int. Cl. B60R 13/01

(52) U.S. Cl. CPC B60R 13/01

(57) ABSTRACT

An apparatus comprises a base plate including a plurality of apertures and a mat. At least a first set of apertures of the plurality of apertures are configured to receive a mounting foot from an accessory to be mounted on the base plate. The mat includes an attachment structure that is selectively securable to the base plate via one or more apertures of the plurality of apertures.

### TECHNICAL FIELD

This disclosure relates generally to a mat that can be selectively secured to a base plate that is used to attach accessories within a cargo or work area of a vehicle.

### BACKGROUND

Vehicles transport various types of cargo. A user can, for example, rely on a vehicle to transport accessories, such as containers and tools, to and from a jobsite. The accessories that need to be transported can vary based on the tasks the user performs at the jobsite. Support surfaces in cargo or work areas may be configured in different ways to securely support the accessories.

### SUMMARY

An apparatus according to an exemplary aspect of the present disclosure includes, among other things: a base plate including a plurality of apertures, wherein at least a first set of apertures of the plurality of apertures are configured to receive a mounting foot from an accessory to be mounted on the base plate; and a mat including an attachment structure that is selectively securable to the base plate via one or more apertures of the plurality of apertures.

In a further non-limiting embodiment of the foregoing apparatus, the base plate is spaced from a bottom surface of a cargo area by a gap, and where the mat is selectively storable within the gap underneath the base plate.

In a further non-limiting embodiment of any of the foregoing apparatuses, the base plate comprises a first base plate positioned at a first vertical position relative to a bottom surface of a cargo area, and including a second base plate positioned at a second vertical position relative to the bottom surface of the cargo area that is above or below the first base plate, and wherein the mat is selectively securable to either the first base plate or the second base plate.

In a further non-limiting embodiment of any of the foregoing apparatuses, an upper surface of the mat has a first vertical height relative to a bottom surface of a cargo area at a first mat end and a second vertical height relative to the bottom surface of the cargo area at a second mat end that is greater than the first vertical height.

In a further non-limiting embodiment of any of the foregoing apparatuses, the cargo area extends from a passenger area to a rear of a vehicle, and wherein the first mat end is positioned at the rear of the vehicle.

In a further non-limiting embodiment of any of the foregoing apparatuses, the mat comprises a central area surrounded by an outer peripheral edge, and wherein the mat has a thickness in the central area that is greater than a thickness of the mat at the outer peripheral edge.

In a further non-limiting embodiment of any of the foregoing apparatuses, the mat includes one or more handles.

In a further non-limiting embodiment of any of the foregoing apparatuses, the mat is comprised of a high density polyethylene plastic.

In a further non-limiting embodiment of any of the foregoing apparatuses, the mat includes a persistent luminescent material.

In a further non-limiting embodiment of any of the foregoing apparatuses, the mat includes one or more mat openings that align with one or more apertures of the plurality of apertures in the base plate, and wherein the attachment structure comprises one or more clips associated with the one or more mat openings and that secure the mat to the base plate while leaving the one or more mat openings uncovered.

In a further non-limiting embodiment of any of the foregoing apparatuses, the attachment structure comprises one or more protrusions formed with the mat that extend into one or more apertures of the plurality of apertures in the base plate.

In a further non-limiting embodiment of any of the foregoing apparatuses, the mat includes one or more mat openings that align with one or more apertures of the plurality of apertures in the base plate, and wherein the attachment structure comprises one or more fasteners that are inserted through the one or more mat openings and into the one or more apertures to secure the mat to the base plate and cover the one or more mat openings.

In a further non-limiting embodiment of any of the foregoing apparatuses, the mat includes one or more mat openings that align with one or more apertures of the plurality of apertures in the base plate, and wherein the attachment structure comprises:
an insert is pressed into the one or more apertures, the insert including a center opening and compressible fingers that extend downwardly around the center opening; and
a post with an enlarged head that is inserted into the center opening to press the compressible fingers outwardly to secure the mat to the base plate.

In a further non-limiting embodiment of any of the foregoing apparatuses, the first set of apertures comprise mounting foot apertures having a first size, and wherein the plurality of apertures include a second set of apertures that comprise locking apertures through which the mat can be fixed to the base plate, wherein the locking apertures have a second size that is different than the first size.

A method according to an exemplary aspect of the present disclosure includes, among other things: providing a plurality apertures in a base plate, wherein at least a first set of apertures of the plurality of apertures are configured to receive a mounting foot from an accessory to be mounted on the base plate; and selectively attaching an attachment structure of a mat to the base plate via one or more apertures of the plurality of apertures.

In a further non-limiting embodiment of the foregoing method, the method includes: storing the mat in an open area underneath the base plate; pulling the mat out of the open area; and securing the mat to an upper surface of the base plate.

In a further non-limiting embodiment of any of the foregoing methods, the method includes: vacuum forming the mat from a high density polyethylene plastic material.

In a further non-limiting embodiment of any of the foregoing methods, the method includes: installing the mat within a cargo area of a vehicle; and positioning a portion of the mat near a passenger area at one end of the cargo area to be at a greater height relative to a portion of the mat in the cargo area near a rear of a vehicle.

In a further non-limiting embodiment of any of the foregoing methods, the method includes: forming a central area of the mat to have a greater thickness than a peripheral edge portion of the mat.

In a further non-limiting embodiment of any of the foregoing methods, the method includes: forming the attachment structure as one or more protrusions in the mat, and inserting the one or more protrusions into one or more apertures of the plurality of apertures in the base plate; or forming one or more mat openings in the mat that align with one or more apertures of the plurality of apertures in the base plate, and wherein the attachment structure comprises a plurality of resilient members that are initially compressed during insertion through the one or more apertures and subsequently expand after insertion to secure the mat to the base plate.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a perspective view of a vehicle cargo bed equipped with a base plate that can be used to secure an accessory.

FIG. 2 illustrates a top view of a mat that can be supported on the base plate according to an exemplary aspect of the present disclosure.

FIG. 3 illustrates a top view of the base plate supporting the mat.

FIG. 4A illustrates a perspective view of a mat supported with a cargo bed similar to that of FIG. 3.

FIG. 4B is a perspective view of the mat supported on an upper base plate.

FIG. 4C is a perspective view of the mat supported on a lower base plate.

FIG. 5 is a section view of one example attachment structure for attaching the mat to the base plate.

FIG. 6 is a perspective view of another example attachment structure for attaching the mat to the base plate.

FIG. 7 is a perspective view of another example attachment structure for attaching the mat to the base plate.

FIG. 8A is an exploded view of another example attachment structure for attaching the mat to the base plate.

FIG. 8B is an initial installation position of the attachment structure of FIG. 8A.

FIG. 8C is a final installation position of the attachment structure of FIG. 8A.

FIG. 8D is a top view of FIG. 8C.

FIG. 9 is a schematic illustration of a mat being position higher near a front of a cargo area than at a rear of the cargo area.

FIG. 10 is a schematic illustration of a mat have a smaller thickness at a peripheral edge and a greater thickness at a center portion of the mat.

### DETAILED DESCRIPTION

This disclosure details a mat that is selectively securable to a base plate that is used with an accessory attachment system for a vehicle. The base plate provides an attachment interface comprising a plurality of apertures for securing the accessories in place within a cargo or work area. There are often situations where it would be useful for the vehicle owner to be able to cover the base plates/apertures with a protective structure such as a mat, for example. The subject disclosure provides mat that can be quickly and efficiently attached to a base plate to provide a continuous and substantially uninterrupted support surface.

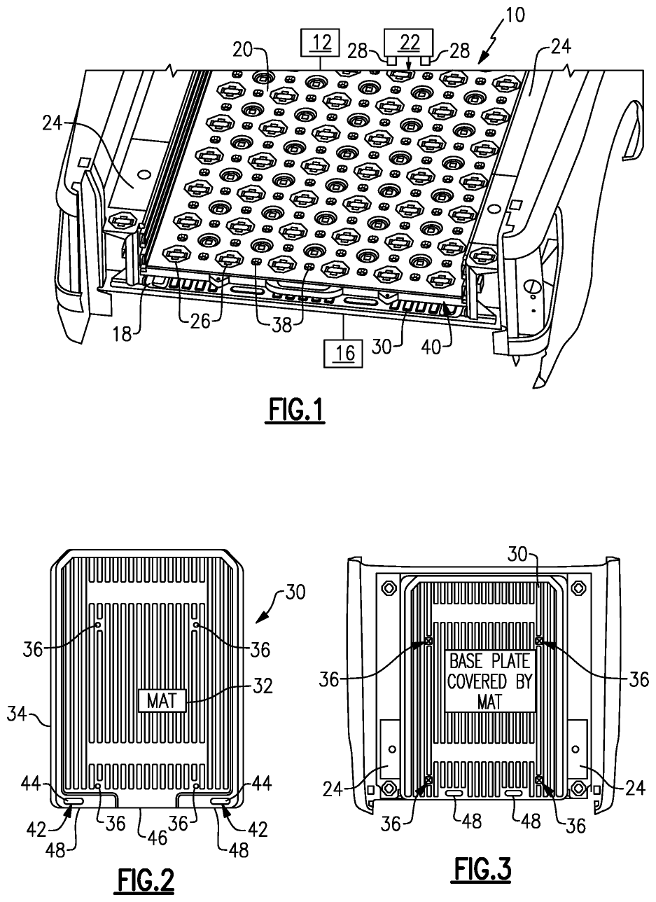

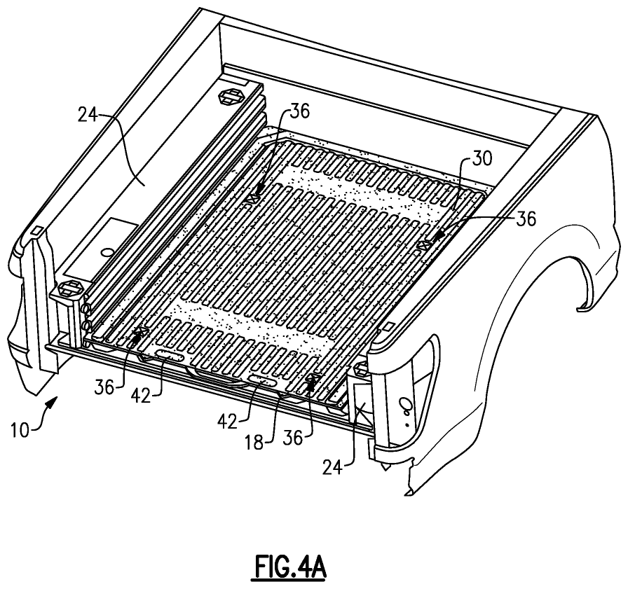

With reference to FIGS. 1-3, a vehicle cargo area 10 has a first end adjacent a passenger compartment 12 and a second end that is at a rear portion 16, e.g., a tailgate, closure panel, etc., of a vehicle. The cargo area 10 has a floor 18. In this example, the vehicle is a pickup truck. However, the vehicle could be another type of vehicle in another example, such as a car, van, sport utility vehicle, etc. The example vehicle could also be a traditional internal combustion engine powered vehicle or an electrified vehicle, such as a battery electric vehicle (BEV) or plug-in hybrid electric vehicle (PHEV) for example.

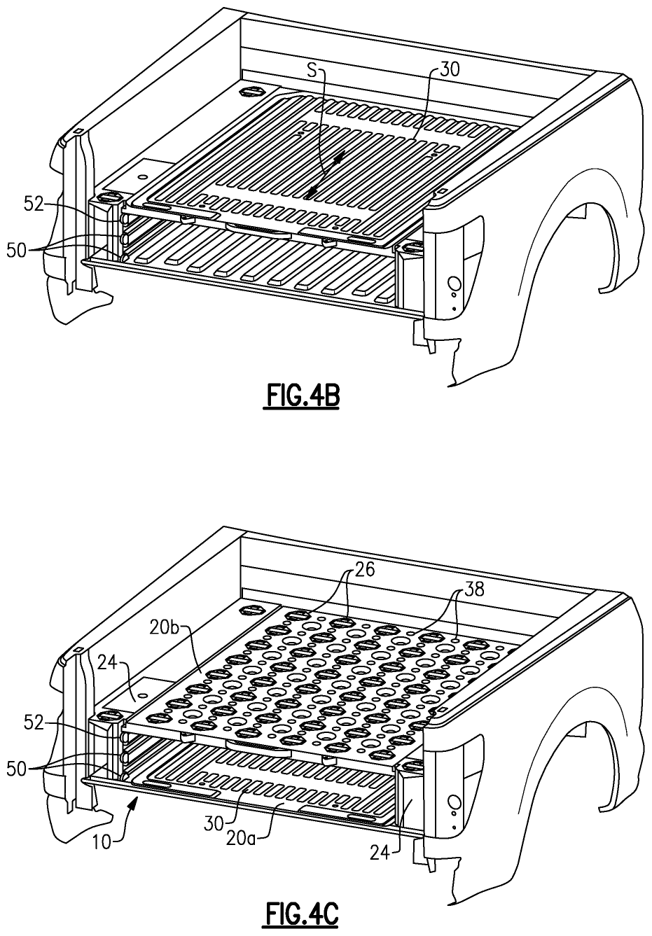

In the exemplary embodiment, one or more base plates 20 are used to support one or more accessories and/or modules 22. In one example, the base plates 20 are secured directly to the floor 18 of the cargo area 10 by fastening, welding, etc., at a first connection interface. In another example shown in FIG. 4B, the base plates 20 can be supported for sliding movement within the cargo area 10 on tracks, rails 24, or other types of sliding structures. An example of such a system with sliding movement is found in application Ser. No. 17/886,663, which was filed on Aug. 12, 2022, which is assigned to the assignee of the subject application, and which is herein incorporated by reference. The accessories and/or modules 22 can be secured to the vehicle by engaging one or more of the base plates 20 via a second connection interface between the accessory 22 and the base plate 20. The accessories/modules 22 can comprise a lockable storage box that holds tools, a container, a refrigerator, etc.

As shown in FIG. 1, the base plate 20 includes a plurality of openings or apertures 26. An example accessory 22 comprises a lockable container or box 22 that includes one or more mounting feet 28. The box 22 can engage the base plate 20 using an attachment system comprising the plurality of apertures 26 and the mounting feet 28 that cooperate to provide a mechanical connection interface. The base plate 20 and the apertures 26 are spaced upwardly from the floor 18 by an open gap such that the feet 28 from the accessory 22 can be easily inserted into the apertures 26 in the base plate 20 to attach the accessory 22 to the base plate 20.

In one example, a mat 30 (FIG. 2) is selectively securable to the base plate 20 to cover the base plate 20 and apertures 26. In one example, the mat 30 comprises a generally rectangular shaped body having a central area 32 surrounded by an outer peripheral edge 34. The mat 30 includes an attachment interface 36 that is used to selectively secure the mat 30 to the base plate 20 via one or more apertures of the plurality of apertures in the base plate 20.

In one example, the apertures 26 that are formed within the base plate 20 comprise a plate attachment interface for accessories 22. However, the base plate 20 can also include additional apertures to provide other attachment features or power connection features. In one example, the base plate 20 includes a plurality of connection and/or lock apertures 38 that interact with the attachment interface 36 of the mat 30. These lock apertures 38 are provided at multiple locations on the base plate 20, and are formed in a desired pattern relative to the apertures 26 for the mounting feet 28 of the accessories 22. In one example, the feet apertures 26 and lock apertures 38 have different sizes and/or shapes. In one example, the lock apertures 38 are smaller in size than the feet apertures 26.

As discussed above, there is an open area 40 underneath the base plate 20. In one example, the mat 30 is selectively storable within this open area 40 when not needed. When the mat 30 is needed, the mat 30 can be easily pulled out of the open area 40 via one or more handles 42, for example, and placed on an upper surface of the base plate 20, The mat 30 can then be secured to the base plate 20 via the attachment interface 36.

In one example, the handles 42 comprise openings 44 integrally formed in the mat 30 near a front edge 46 of the mat 30. The openings 44 provide for a grip portion 48 that can be grasped by a user to pull the mat 30 out of the open area 40 and/or to pull the mat 30 upwardly away from the base plate 20 for detachment purposes.

When in the stowed/storage position, the mat 30 can rest on the floor 18 of the cargo area 10 as shown in FIG. 4A. Optionally, a plurality of base plates 20 can be mounted within with the tracks/rails 24 to provide different support surface heights. FIG. 4B shows an example where the mat 30 is supported on a base plate 20 that has been slid out from a lower position 50 and slid into a higher position 52 (see arrow S).

FIG. 4C shows an example where the base plate comprises a first base plate 20a positioned at the lower position 50, i.e., a first vertical position relative to a bottom surface of the cargo area, and a second base plate 20b is provided that is positioned at the higher position 52, i.e., a second vertical position relative to the bottom surface of the cargo area that is above the first base plate 20a. The mat 30 is selectively securable to either the first base plate 20a or the second base plate 20b. Optionally, each base plate 20 could be covered by a mat 30. In the example shown in FIG. 4C, the mat 30 is attached to the lower base plate 20a.

FIG. 5 shows one example of the attachment structure 36. In this example, the attachment structure 36 comprises one or more protrusions 62 formed with the mat 30. In one example, there are at least four protrusion 62, e.g., one spaced inward from each corner of the mat 30, that extend into corresponding lock apertures 38 in the base plate 20. The protrusions 62 can be integrally formed with the mat 30 or separately attached thereto. Further, fewer or additional protrusions can be used as needed.

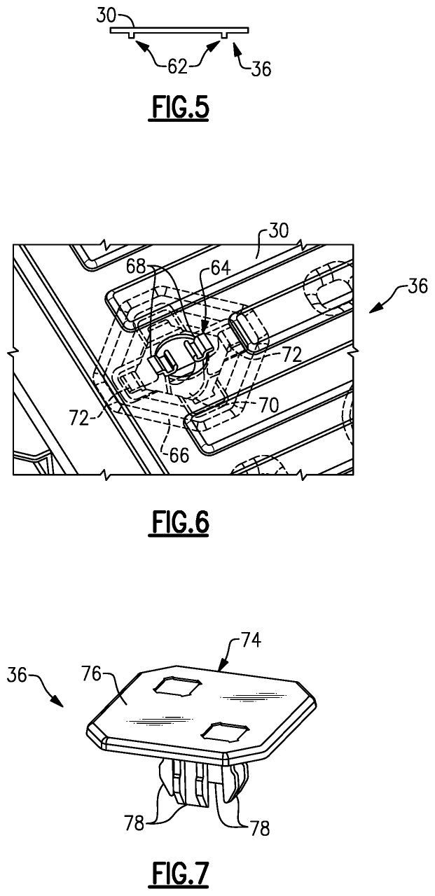

FIG. 6 shows another example of the attachment structure 36. In this example, the attachment structure 36 comprises one or more clips 64. In one example, there are at least four clips 64, e.g., one spaced inward from each corner of the mat 30, that extend into corresponding lock apertures 38 in the base plate 20. Fewer or additional clips 64 can be used as needed. In this example, the attachment structure 36 further comprises mat openings 66 that align with the lock apertures 38 of the base plate 20. In this example configuration, the clips 64 are associated with the mat openings 66 and secure the mat 30 to the base plate 20 while leaving the mat openings 66 uncovered. The base plate lock openings 38 may also be accessible in this configuration.

In one example, the clips 64 comprise at least two compressible tabs or fingers 68 that are connected to each other via a U-shaped body portion 70, and a second pair of compressible tabs or fingers 72 are outward of the first pair of compressible tabs or fingers 68. The second pair of compressible tabs or fingers 72 are underneath the mat 30 and are associated with the base plate 20, and the first pair of compressible tabs or fingers 68 extend through the mat openings 66. The first pair of compressible tabs or fingers 68 are compressed inwardly toward each other to fit through the openings 66 and then expand outwardly to secure the mat 30 to the base plate 20.

FIG. 7 shows another example of the attachment structure 36. In this example, the attachment structure 36 comprises one or more fasteners 74. In one example, there are at least four fasteners 74, e.g., one spaced inward from each corner of the mat 30, that extend into corresponding lock apertures 38 in the base plate 20. Fewer or additional fasteners 74 can be used as needed. In this example, the attachment structure 36 further comprises the mat openings 66 that align with the lock apertures 38 of the base plate 20. In this example configuration, the fasteners 74 are associated with the mat openings 66 and secure the mat 30 to the base plate 20 while leaving the mat openings 66 and lock openings 38 covered. In one example, the fasteners 74 comprise a flat base 76 with a center extension comprising a plurality of compressible tabs or fingers 78 that are inserted through the mat openings 66 and into the lock apertures 38 to secure the mat 30 to the base plate 20 such that the base 76 covers the mat openings 66. The compressible tabs or fingers 78 compress inwardly during insertion and expand outwardly once inserted. A user can grip the base 76 to pull the fastener 74 away from the mat, or the handles 42 can be used to lift the fasteners 74 out.

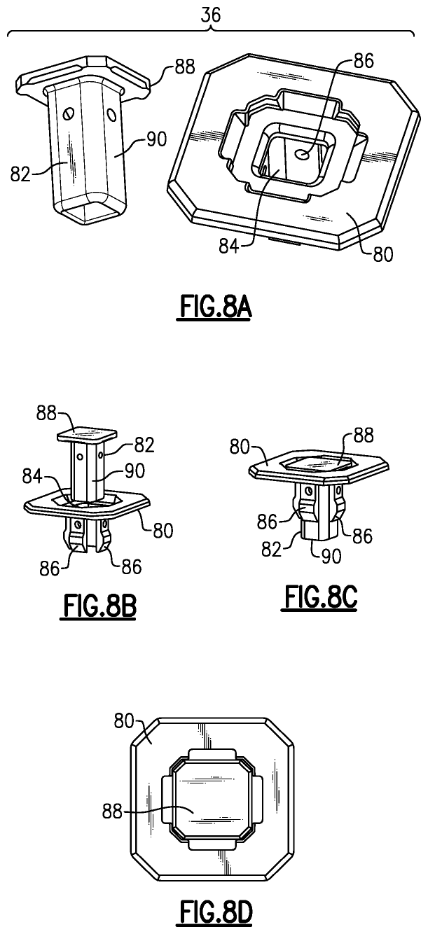

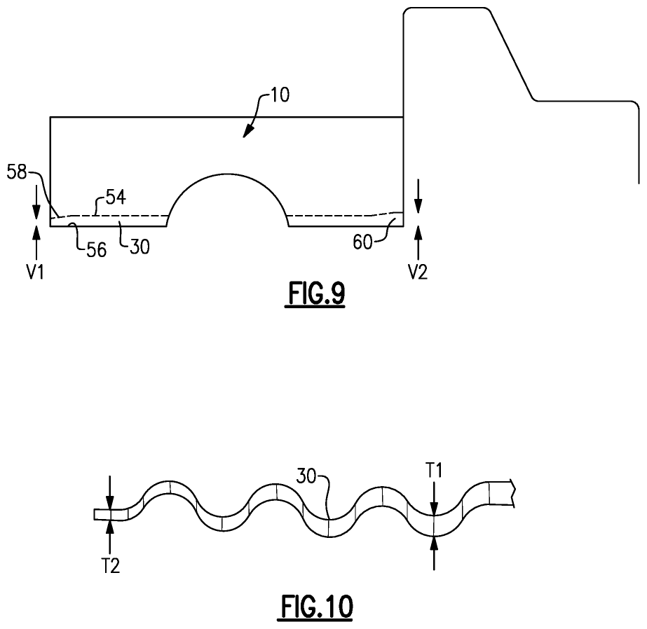

FIGS. 8A-8D show another example of the attachment structure 36. In this example, the attachment structure 36 comprises one or more inserts 80 and posts 82. In one example, there are at least four sets of inserts and posts, e.g., one set spaced inward from each corner of the mat 30, that extend into corresponding lock apertures 38 in the base plate 20. Fewer or additional sets of inserts and posts can be used as needed. In this example, the attachment structure 36 further comprises the mat openings 66 that align with the lock apertures 38 of the base plate 20. In this example configuration, the inserts 80 and posts 82 are associated with the mat openings 66 and secure the mat 30 to the base plate 20 while leaving the mat openings 66 and lock openings 38 covered.

In one example, the insert 80 is first pressed into the corresponding lock apertures 38. The insert 80 includes a center opening 84 and compressible fingers 86 that extend downwardly around the center opening 84. In one example, the post 82 comprises an enlarged head 88 with a reduced linear portion 90 extending away from the head 88. The linear portion 90 is inserted into the center opening 84 to press the compressible fingers 86 outwardly to secure the mat 30 to the base plate 20. In this example, a tool (not shown) may be required to pull out the post 82.

As shown schematically in FIG. 9, an upper surface 54 of the mat 30 has a first vertical V1 height relative to a bottom surface 56 of the cargo area 10 at a first mat end 58 and a second vertical height V2 relative to the bottom surface 56 of the cargo area 10 at a second mat end 60 that is greater than the first vertical height V1. This allows for drainage to be managed in a desired direction. In one example, the cargo area 10 extends from the passenger compartment 12 to the rear portion 16, e.g., a tailgate, closure panel, etc., of the vehicle, and the first mat end 58 is positioned at the rear portion 16 of the vehicle such that fluids can drain away from the passenger compartment 12.

As discussed above, the mat 30 comprises a central area 32 that is surrounded by an outer peripheral edge 34. In one example, the mat 30 has a thickness T1 in the central area 32 that is greater than a thickness T2 of the mat 30 at the outer peripheral edge 34 as shown in FIG. 10. This configuration can facilitate sealing. For example, the mat 30 seals at the edges 34 by being stretched more at the periphery to make these edges 34 more flexible by having a thinner wall thickness. In one example, the cross-section of the mat 30 comprises a wave pattern to give a thinner wall thickness as shown in FIG. 10.

In one example, the mat 30 is comprised of low friction material, e.g., a high density polyethylene (HDPE) plastic or other similar materials. Further, the mat 30 have varying degrees of softness/hardness. In one example, the mat 30 is vacuum formed; however, other forming processes could also be used. The use of a low friction plastic material allows the mat 30 to slide out when pulled by the handles 42 at the front edge 46 of the mat 30.

In one example, the mat includes a persistent luminescent material, e.g., glow-in-the-dark phosphors. In one example, this material is molded in combination with the plastic material. This can provide lighting underneath the base plate 20 when the mat 30 is in a stowed position. The phosphor material is charged during the day from light coming through openings in the base plate and then can glow at night to provide a supplemental light source.

The subject disclosure provides for a mat that goes into a cargo bed underneath the base plate. The mat protects the bed from water and debris, is easy to be pulled out to be cleaned, and can be selectively locked in place on the base plate. Handles are provided for pulling out the mat which can be comprised of a low friction plastic to further facilitate sliding movement. Water management, e.g., drainage control, is also provided as the mat is higher in near the cabin than at the rear of the vehicle so water can run out. Further, the mat is thinned out on the edges so a friction fit sealing against the vehicle one bed can be created.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. An apparatus, comprising:
a base plate including a plurality of apertures, wherein at least a first set of apertures of the plurality of apertures are configured to receive a mounting foot from an accessory to be mounted on the base plate; and
a mat including an attachment structure that is selectively securable to the base plate via one or more apertures of the plurality of apertures.

2. The apparatus of claim 1, wherein the base plate is spaced from a bottom surface of a cargo area by a gap, and wherein the mat is selectively storable within the gap underneath the base plate.

3. The apparatus of claim 1, wherein the base plate comprises a first base plate positioned at a first vertical position relative to a bottom surface of a cargo area, and including a second base plate positioned at a second vertical position relative to the bottom surface of the cargo area that is above or below the first base plate, and wherein the mat is selectively securable to either the first base plate or the second base plate.

4. The apparatus of claim 1, wherein an upper surface of the mat has a first vertical height relative to a bottom surface of a cargo area at a first mat end and a second vertical height relative to the bottom surface of the cargo area at a second mat end that is greater than the first vertical height.

5. The apparatus of claim 4, wherein the cargo area extends from a passenger area to a rear of a vehicle, and wherein the first mat end is positioned at the rear of the vehicle.

6. The apparatus of claim 1, wherein the mat comprises a central area surrounded by an outer peripheral edge, and wherein the mat has a thickness in the central area that is greater than a thickness of the mat at the outer peripheral edge.

7. The apparatus of claim 1, wherein the mat includes one or more handles.

8. The apparatus of claim 1, wherein the mat is comprised of a high density polyethylene plastic.

9. The apparatus of claim 1, wherein the mat includes a persistent luminescent material.

10. The apparatus of claim 1, wherein the mat includes one or more mat openings that align with one or more apertures of the plurality of apertures in the base plate, and wherein the attachment structure comprises one or more clips associated with the one or more mat openings and that secure the mat to the base plate while leaving the one or more mat openings uncovered.

11. The apparatus of claim 1, wherein the attachment structure comprises one or more protrusions formed with the mat that extend into one or more apertures of the plurality of apertures in the base plate.

12. The apparatus of claim 1, wherein the mat includes one or more mat openings that align with one or more apertures of the plurality of apertures in the base plate, and wherein the attachment structure comprises one or more fasteners that are inserted through the one or more mat openings and into the one or more apertures to secure the mat to the base plate and cover the one or more mat openings.

13. The apparatus of claim 1, wherein the mat includes one or more mat openings that align with one or more apertures of the plurality of apertures in the base plate, and wherein the attachment structure comprises:
an insert is pressed into the one or more apertures, the insert including a center opening and compressible fingers that extend downwardly around the center opening; and
a post with an enlarged head that is inserted into the center opening to press the compressible fingers outwardly to secure the mat to the base plate.

14. The apparatus of claim 1, wherein the first set of apertures comprise mounting foot apertures having a first size, and wherein the plurality of apertures include a second set of apertures that comprise locking apertures through which the mat can be fixed to the base plate, wherein the locking apertures have a second size that is different than the first size.

15. A method comprising:
providing a plurality of apertures in a base plate, wherein at least a first set of apertures of the plurality of apertures are configured to receive a mounting foot from an accessory to be mounted on the base plate; and
selectively attaching an attachment structure of a mat to the base plate via one or more apertures of the plurality of apertures.

16. The method of claim 15, including:
storing the mat in an open area underneath the base plate;
pulling the mat out of the open area; and
securing the mat to an upper surface of the base plate.

17. The method of claim 15, including vacuum forming the mat from a high density polyethylene plastic material.

18. The method of claim 15, including installing the mat within a cargo area of a vehicle, and positioning a portion of the mat near a passenger area at one end of the cargo area to be at a greater height relative to a portion of the mat in the cargo area near a rear of a vehicle.

19. The method of claim 15, including forming a central area of the mat to have a greater thickness than a peripheral edge portion of the mat.

20. The method of claim 15, including:
forming the attachment structure as one or more protrusions in the mat, and inserting the one or more protrusions into one or more apertures of the plurality of apertures in the base plate; or
forming one or more mat openings in the mat that align with one or more apertures of the plurality of apertures in the base plate, and wherein the attachment structure comprises a plurality of resilient members that are initially compressed during insertion through the one or more apertures and subsequently expand after insertion to secure the mat to the base plate.
